(19) United States
(12) Patent Application Publication
(10) Pub. No.: US 2015/0127638 A1
(43) Pub. Date: May 7, 2015

(54) AUTOMATIC SELECTION OF AN INTERMEDIATE DATING LOCATION

(71) Applicant: MATCH.COM, L.L.C., Dallas, TX (US)

(72) Inventors: Brian Jacob Parks, Dallas, TX (US); Pearson James Stewart, Rowlett, TX (US); Anna Sue Bixby, Dallas, TX (US)

(73) Assignee: MATCH.COM, L.L.C., Dallas, TX (US)

(21) Appl. No.: 14/071,266

(22) Filed: Nov. 4, 2013

(51) Int. Cl. G06F 17/30

(52) U.S. Cl. CPC G06F 17/3053
USPC 707/723; 707/722

(57) ABSTRACT

In an example, a system and method are disclosed for providing functionality for two users of a matching service, such as an online dating service, to identify a midpoint at which they may conveniently meet. User locations may be based on exact coordinates, or may be more generalized, such as by zip code or city. A midpoint is identified, which may be a geographic center, or which may be a relatively-centralized place of interest. In some cases, a plurality of potential meeting locations are displayed and are ranked for the user.

### TECHNICAL FIELD

This disclosure relates in general to the field of communications and, more particularly, to a system and a method for initiating social interactions between users in a network environment.

### BACKGROUND

Communications network architectures have experienced significant notoriety because they can offer the benefits of automation, convenience, and data management for their respective online communities. Certain network protocols may be used in order to allow an end user to be matched to other end users or to scenarios in which they stand to benefit (e.g., job searches, person-finding services, real estate searches, online dating, etc.).

In the case of an online dating service, for example, an end user will typically be prompted to specify a variety of preferences to be used in matching the end user with other end users in a particular online dating community. The information each end user provides about him or herself may be viewed by other end users in the online community in determining whether to interact with that end user. In certain cases, the actual dating platform can participate in matching activities. This interventionist involvement and often spur or provoke new relationships being formed.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a network diagram showing an operating environment of the present disclosure in accordance with one embodiment of the present disclosure;

FIGS. 2A-J are simplified screen shots of an example protocol for participating in an on-line dating service in accordance with one embodiment of the present disclosure;

FIGS. 3-10 are simplified screen shots of an example protocol for registering with and submitting a date request using a Blind Date Request (“BDR”) feature of an on-line dating service, such as illustrated in FIGS. 1-2J, in accordance with one embodiment of the present disclosure;

FIGS. 11-19 are simplified screen shots of an example protocol for scheduling a blind date using the BDR feature of an on-line dating service, such as illustrated in FIGS. 1-2J, in accordance with one embodiment of the present disclosure;

FIG. 20 is a flow diagram illustrating logic implemented by a BDR feature of one embodiment of the present disclosure; and

FIGS. 21-22 are a more detailed flow diagram illustrating logic implemented by a BDR feature of one embodiment of the present disclosure.

FIG. 23 is a plan view of a geographic region in which two users are located according to one or more example embodiments of the present specification.

FIG. 24 is a diagrammatic view of a search radius according to one or more example embodiments of the present specification.

FIG. 25 is a network diagram of a web server accessing one or more third-party APIs according to one or more example embodiments of the present specification.

FIG. 26 is a flow diagram of a method of identifying a geographic center according to one or more example embodiments of the present specification.

### DETAILED DESCRIPTION OF EXAMPLE EMBODIMENTS

### Overview

In an example, a system and method are disclosed for providing functionality for two users of a matching service, such as an online dating service, to identify a midpoint at which they may conveniently meet. User locations may be based on exact coordinates, or may be more generalized, such as by zip code or city. A midpoint is identified, which may be a geographic center, or which may be a relatively-centralized place of interest. In some cases, a plurality of potential meeting locations are displayed and are ranked for the user.

### Example Embodiments

A matching service such as a dating service may use algorithms and profile matching to determine a likely best match for a user. A goal of this matching is to facilitate an ultimate in-person meeting. As users progress toward an in-person meeting, it may be awkward or difficult for them to identify an ideal location. Thus, the present specification discloses a system and method for automatically selecting an intermediate area and presenting the respective users with a plurality of options within that area.

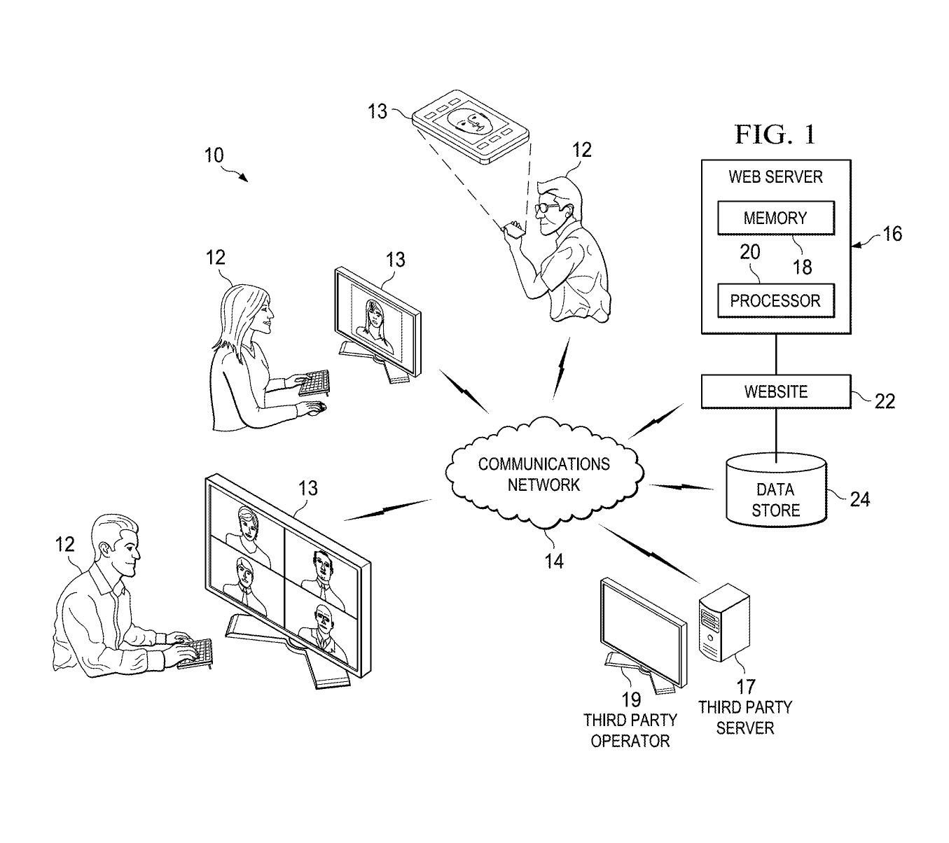

FIG. 1 is a simplified block diagram of a system 10 for facilitating an online dating scenario in a network environment. In other embodiments in which communications or matching is valuable, system 10 can be leveraged to identify and to evaluate suitable candidates in other areas (e.g., hiring/employment, recruiting, real estate, general person searches, etc.). FIG. 1 includes multiple end users 12 and endpoints 13, a communications network 14, a web server 16 comprising memory 18 and a at least one processor 20, a website 22, and a data store 24. Data store 24 may be any type of mechanism for storing data, including but not limited to one or more files, databases, memory devices, mass storage devices, data centers, etc. System 10, users 12 interact with web server 16 via endpoints 13, each of which comprises an appropriate user interface for interacting with web server 16 via website 22 for facilitating matching and/or location identifying functions and features described herein. In certain example implementations, website 22 and web server 16 are consolidated into a single component, physical structure, equipment, etc. Throughout this specification, it is understood by way of example that server 16 is a server operated by an online dating service. It should be noted, however, that any type of matching service could operate server 16, or any service that can benefit from the system and method disclosed herein. It is therefore intended that this disclosure not be limited to online dating services. Accordingly, in this specification, a “server” is defined as any computing device configured to communicatively couple to a network and to provide data over the network.”

Server 16 may be communicatively coupled to one or more third-party servers 17 via communications network 14. Third-party severs 17 may be configured to provide information useful in implementing the system and method disclosed herein, including via an application programming interface.

FIG. 1 may be configured such that inter- and intra-communications are readily achieved by any of the components included therein. The present disclosure is capable of providing both an online component (as illustrated in FIG. 1) and an off-line component such that one or more end users can meet, gather information, resolve to meet, and then subsequently meet in person with the assistance of system 10. Ancillary components to such a comprehensive process may involve pre-date profiles, post-date follow-ups, and a myriad of other significant features, some of which are outlined in greater detail below.

End users 12 may include a variety of types of end users, such as clients, customers, prospective customers, or entities wishing to participate in an online dating scenario and/or to view information associated with other participants in the system. End users 12 may also seek to access or to initiate communications with other end users that may be delivered via communications network 14. End users 12 may review data (such as user profiles, for example) associated with other users in order to make matching decisions or selections. Data, as used herein in this document, refers to any type of numeric, voice, video, or script data, or any other suitable information in any appropriate format that may be communicated from one point to another.

End users 12 may access the aforementioned data via endpoints 13, which may be inclusive of devices used to initiate a communication. Note that the broad term “user” encompasses any type of node or user device, or any type of endpoint discussed herein. Additionally, the term “user” can further include any type of profile to be used in the system discussed herein. Hence, the term “user” can include (but is not limited to) elements such as a computer, a personal digital assistant (PDA), a laptop or electronic notebook, a cellular telephone, an IP telephone, an iPhone™, an iPad™, a Microsoft Surface™, an Android™ phone, a Google Nexus™, or any other device, component, element, or object capable of initiating voice, audio, or data exchanges within communication system 10. The endpoints may be inclusive of a suitable interface to the end user 12, such as a microphone, a display, or a keyboard or other terminal equipment. Endpoints 13 may also include any device that seeks to initiate a communication on behalf of another entity or element, such as a program, a database, or any other component, device, element, or object capable of initiating a voice or a data exchange within communication system 10. In addition, each of the endpoints 13 may be a unique element designed specifically for communications involving system 10. Such an element may be fabricated or produced specifically for matching applications involving end user 12 and endpoint 13.

A user may employ any device capable of operating as an endpoint 13 to connect to communications network 14 via wire, wireless, cellular, satellite link or other suitable interfaces. Web server 16, which as previously noted includes memory 18 and at least one processor 20, hosts website 22 and has access to transmit and receive user or presence data (e.g., user profile data, user and/or user endpoint data, user contact data) from database 24. Presence data may be collected, aggregated, and utilized as required to facilitate communications between endpoints 12 over communications network 10 or other outside communication systems. Presence data may also include information and/or instructions enabling the creation, duration, and termination of communication sessions between diverse endpoints 13 that utilize different communication and/or networking protocols.

Communications network 14 is a communicative platform operable to exchange data or information emanating from endpoints 13. Communications network 14 represents an Internet architecture in a particular embodiment of the present disclosure, which provides end users 12 with the ability to electronically execute or to initiate actions associated with finding a potential match candidate. Alternatively, communications network 14 could be a plain old telephone system (POTS), which end user 12 could use to perform the same operations or functions. Such transactions may be assisted by management associated with website 22 or manually keyed into a telephone or other suitable electronic equipment. In other embodiments, communications network 14 could be any packet data network (PDN) offering a communications interface or exchange between any two nodes in system 10. Communications network 14 may alternatively be any local area network (LAN), metropolitan area network (MAN), wide area network (WAN), wireless local area network (WLAN), virtual private network (VPN), intranet, or any other appropriate architecture or system that facilitates communications in a network or telephonic environment.

In one embodiment, web server 16 comprises a server that is operable to receive and to communicate information to one or more end users 12. In a generic sense, web server 16 can implement a computer-implemented matching system that provides a framework for suitable matching activities. Alternatively, web server 16 may be any switch, router, gateway, cache, server blade, software, processor, proprietary component, object, module, or element (or any combination of these) operable to facilitate communications involving end user 12. Web server 16 may be integrated with database 24 and/or website 22, where any one or more of these elements may share or otherwise coordinate the activities discussed herein.

In one particular embodiment, web server 16, via interaction with database 24 and/or in conjunction with website 22, is engaged in facilitating interaction(s) between parties interested in seeking a romantic partner (i.e., online dating). For example, website 22 can be online dating service provider www.Match.com, www.Chemistry.com, or any other suitable provider. In certain example scenarios, a given end user may pay a fee for a subscription-based service. Additionally, certain end user fee structures may apply to different tiers of service: some of which may entitle an end user to enhanced features on website 22 (e.g., the ability to communicate more frequently with other users, additional matches being provided (potentially, more frequently) to an end user who paid the higher fee structure, the ability to store data, the ability to share data, the ability to upload additional information, the ability to target specific searches based on particular criteria, the ability to receive preferential positioning in the context of being matched to other users, the ability to perform video calls (e.g., Skype, etc.) with other users, the ability to perform audio calls with other users, etc.).

In certain embodiments, website 22 is a computer-implemented matching system, which may be any website or architecture provided for facilitating a connection involving two or more people, and which may make use of a given profile, photograph, resume, article description, etc. This could include services associated with job placements, escort services, auction services, social media, real estate listings, recruiting services (e.g., in athletics, academia, employment scenarios, instances involving the sales of goods and services), etc.

Considerable flexibility is provided by the structure of web server 16 and website 22 in the context of system 10. Thus, it can be easily appreciated that such matching and/or location identifying functions could be provided external to web server 16 or website 22. In such cases, such a functionality could be readily embodied in a separate component, server, processor, device, or module. Note that these online dating features and capabilities may be provided in just one of these elements, in both, or distributed across both of them. Hence, in certain embodiments, the online dating operations may be consolidated in a single website, where no redirection is needed, nor performed for the user.

In operation of an example embodiment, consider a case where a given end user is interested in participating in an online dating scenario. End user 12 can access website 22 via the communications network 14 (which in the example presented comprises the Internet) using endpoint 13, register, and create a profile on the site. Moreover, end user 12 can access website 22 through any suitable banner, pop-up, partnership, e-mail solicitations, direct mailings, etc. It can be appreciated that online commerce can be generated by a plethora of marketing tools and any such tools can readily cooperate with the operations of the present disclosure.

At this point, matching of any form can commence amongst the members of the online community. For example, in the context of a romantic endeavor, a person may begin the dating process or engage in communications that would spawn such dating. Other applications could include job applicants who are being sought by employers. Any of the individuals who reside in the online community can begin using any of the tools or capabilities of the platform.

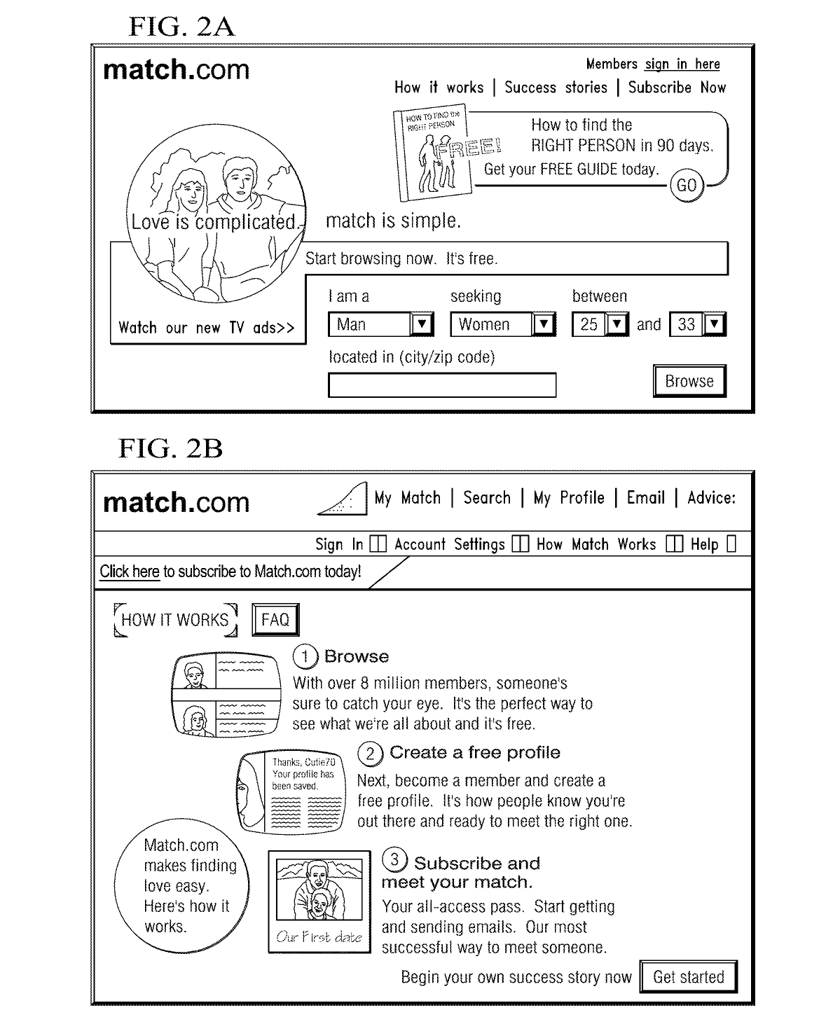

FIGS. 2A-2J illustrate example screen shots that may be provided in the online dating process to facilitate presentation of information to and gathering of information from member end users. FIGS. 2A-2J are presented herein for purposes of discussion. It is imperative to note that these illustrations are only being provided to further outline a particular implementation of the present disclosure. In no way should these diagrams be used to limit or to restrict the broad teachings of the present disclosure. Such illustrative information has been offered earnestly and, thus, should not be construed to confine the broad applications of the present disclosure.

FIG. 2A is an example screen shot of a home page from which an interested end user may begin his/her journey. In the illustrated example, the home page solicits location information, such as a city or zip code, as well as an indication of the end user's gender and an age range and gender preference of persons the end user is interested in “meeting” via system 10. Subsequent to the end user's completion of the requested information and clicking on a “How it Works” icon on the home page of FIG. 2A, a screen shot as shown in FIG. 2B is presented to the end user. The screen shot of FIG. 2B provides a generic outline of the online dating process. As outlined in the screen shot of FIG. 2B, as a first step, an end user may choose to browse the website to view pictures of members along with summaries of the members' profiles. After browsing the website, the end user may decide to create a free profile. Once the end user browses the website and creates a profile, the end user may opt to subscribe to the service and receive information from/about others who are part of the online community. For purposes of example and ease of explanation, it will be assumed for the remainder of the discussion of FIGS. 2A-2D that the potential new end user investigating and ultimately subscribing to the service is a male named “Tom” who is interested in finding a female match.

FIG. 2C is an example screen shot of a number of profiles that may be viewed by Tom during the browsing phase described above. In the context of this shot, Tom may be simply browsing. Assuming Tom has decided he would like to know more about one of the members whose profile is presented in FIG. 2C, he may click on the picture associated with the selected profile. For example, assuming Tom has decided he would like more information about “LadyDi520”, clicking on her picture results in his being directed to a web page as shown in FIG. 2D, where he is solicited to sign up for the online dating subscription such that he can effectively contact his candidate selection. It will be noted that the information solicited using the page shown in FIG. 2C may be used in selecting matches for Tom. The information may also be displayed on Tom's profile or summary thereof presented to other users to assist those users in determining whether they are interested in interacting with him.

FIGS. 2E-2G illustrate various screen shots comprising a user information collection process in accordance with one embodiment. Using the web pages illustrated in FIGS. 2E-2G, system 10 collects a variety of information from an end user, including, but not limited to, basic information about the end user (FIG. 2E), as well as information about the type person the end user would be interested in dating, including information about a potential date's physical appearance (FIG. 2F) and background and values (FIG. 2G). It will be recognized that the information collected using the web pages illustrated in FIGS. 2E-2G is illustrative only and that any type/amount of information may be solicited in the illustrated manner.

FIGS. 2H-2J are example screen shots of the full profile of LadyDi520, the picture Tom selected while browsing. In illustrated profile, LadyDi520's match criteria are displayed, as well as other information that may be pertinent to a potential mate. Any suitable items can be provided in such a profile (such as interests, favorite hot spots, favorite things, desire for children, background, etc.). Virtually any type or format of information (inclusive of video and audio data) may be provided in such a profile. In particular, the profile includes information that was solicited from LadyDi520 when she set up her online dating account. The profile may include a photo, biographical information (e.g., gender, age, location, relationship status, etc.), physical information (e.g., height, weight, hair and eye color, etc.), interests (e.g., hobbies, “favorites,” etc.), lifestyle information (e.g., exercise habits, employment, smoking/drinking habits, etc.), and background/values (e.g., ethnicity, faith, education, etc.). The profile may also include a section entitled “About My Date,” in which the end user specifies preferences about the type of person he/she would like to meet/date (e.g., appearance, interests, faith, education, relationship goals, etc.). In some embodiments, a full profile, including the profile information provided by the end user and stored in the system, is displayed to interested viewers; in other embodiments, only a summary or subset of the profile information is displayed.

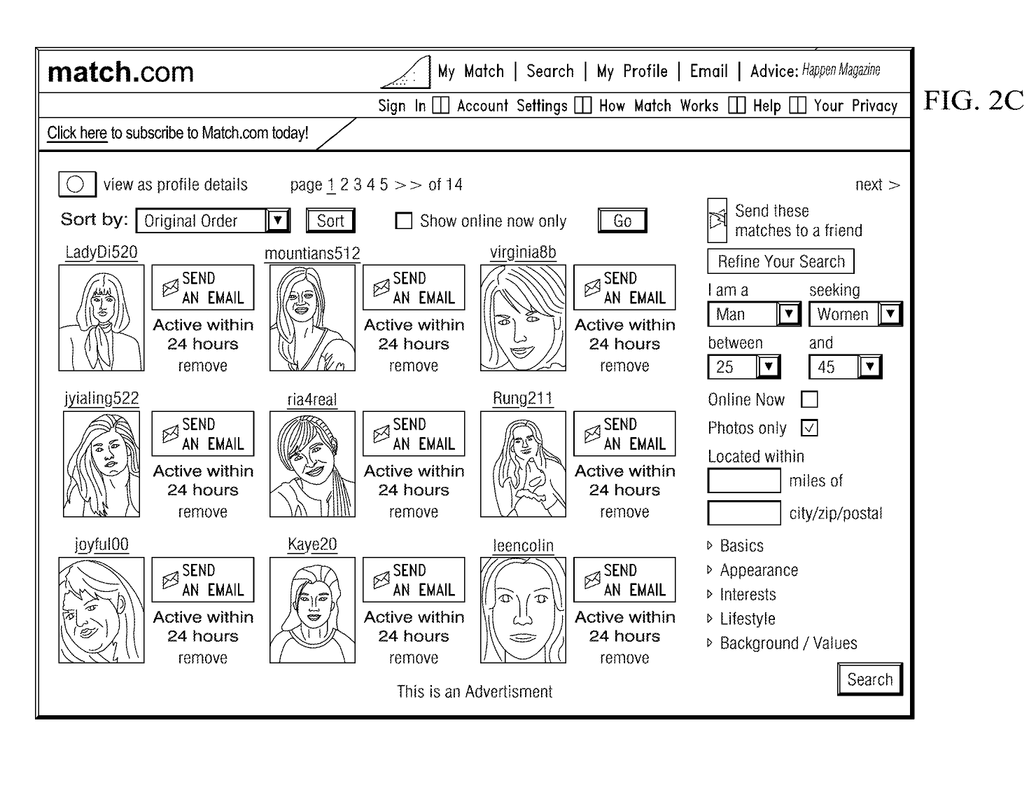

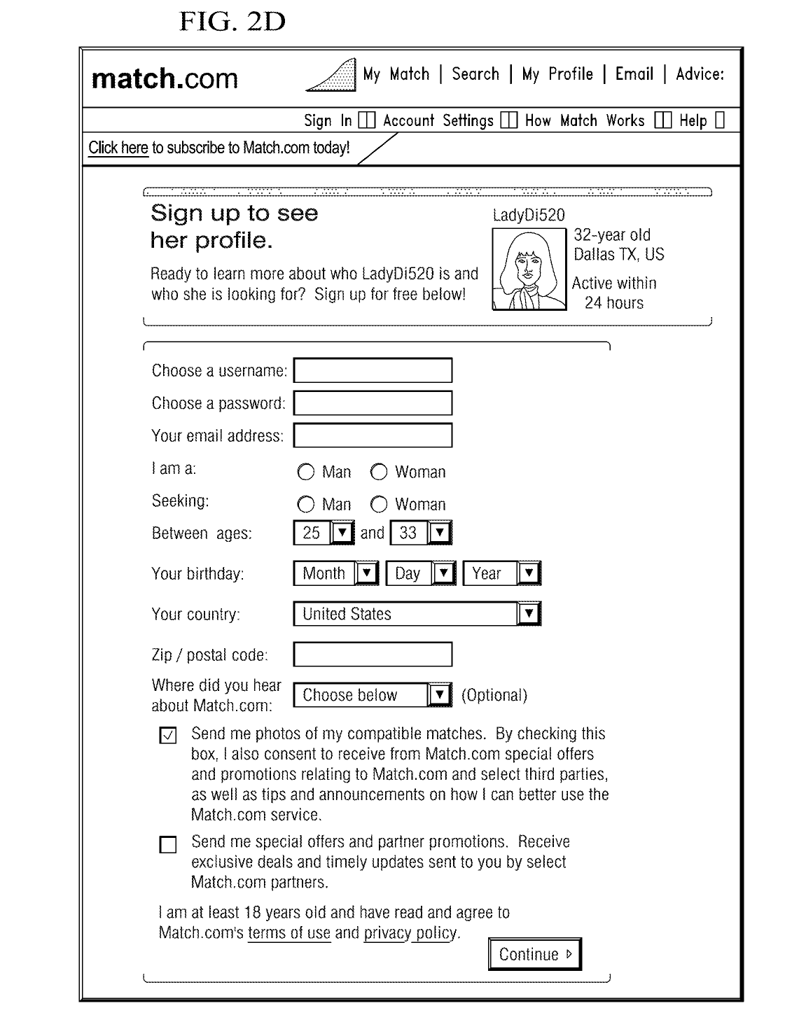

In one embodiment, the system 10 may include a feature referred to herein as a Blind Date Request (“BDR”) feature. The BDR feature may be accessed in any number of known manners, including clicking on a link, icon, or other element provided in a GUI displayed on a web page. Alternatively, the BDR feature may be implemented as a standalone feature. In certain cases, the BDR feature can be provided as an application (“app”) that is readily downloaded and/or purchased from an app provider (e.g., iTunes™, match.com™, etc.). Once a user accesses the BDR feature, he or she may be required to create a special BDR account or to sign in using an existing account, as illustrated in FIG. 3. To create a new BDR account, as illustrated in FIG. 4, various information is solicited from the user, including, for example, the user's first name, birth date, gender, and the gender the user is seeking to date. The user is also prompted to click on a camera icon 30 to take a photo of himself or herself or to select a photo from photos that have already been uploaded to the system 10 or are stored on the endpoint equipment employed by the user.

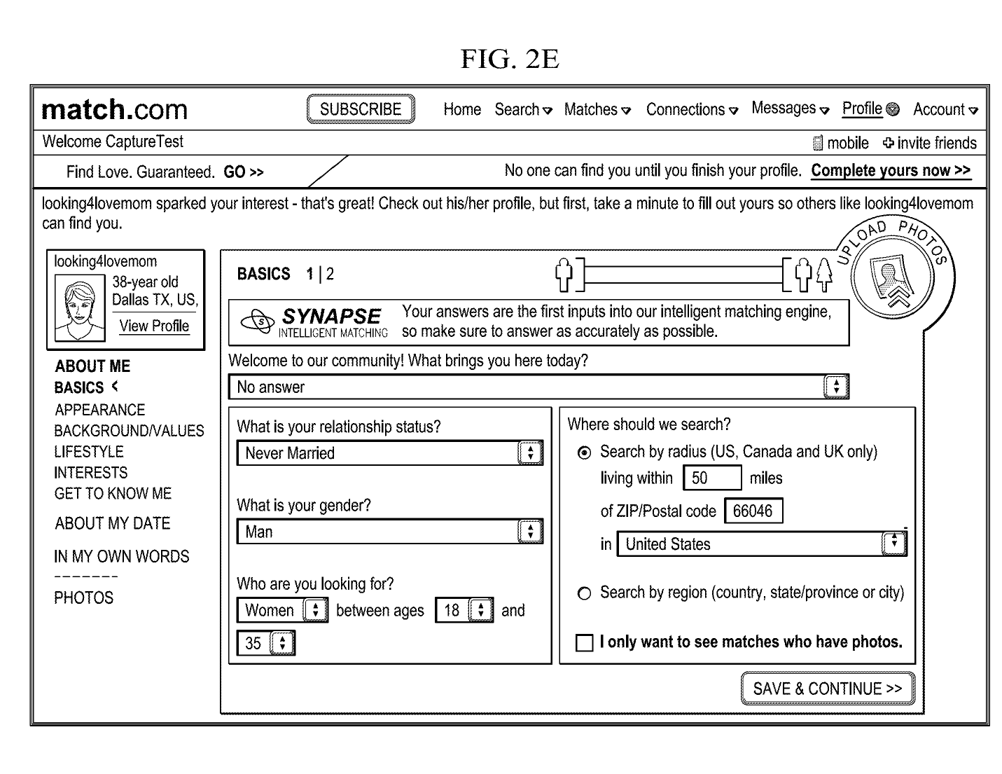

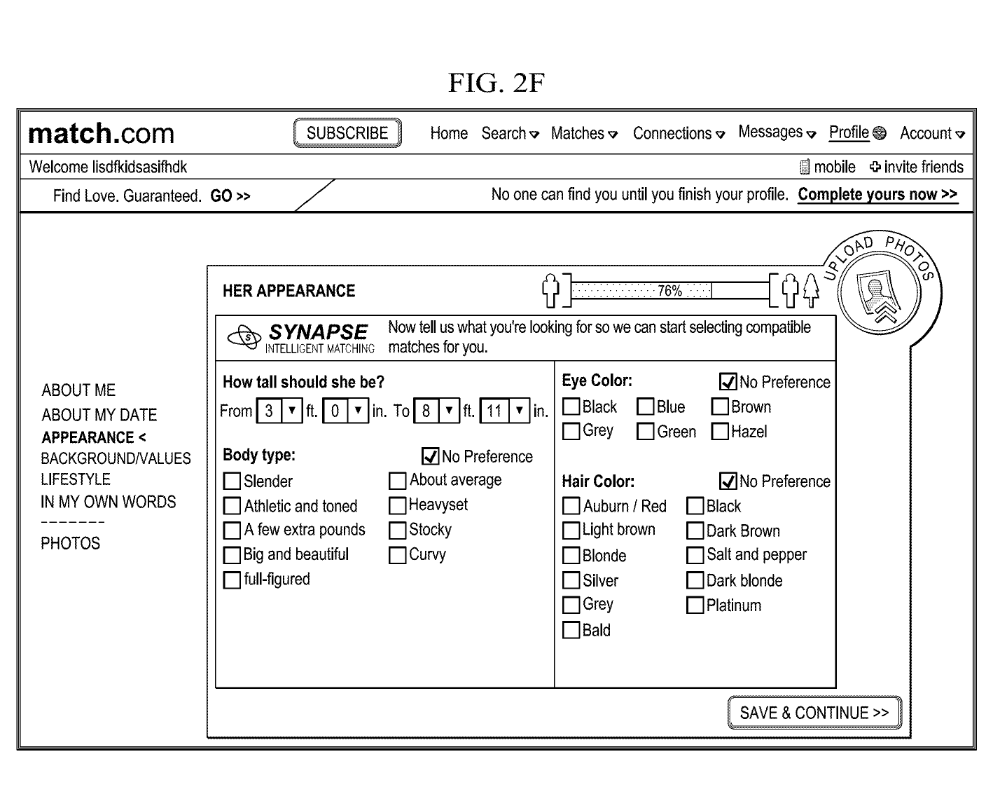

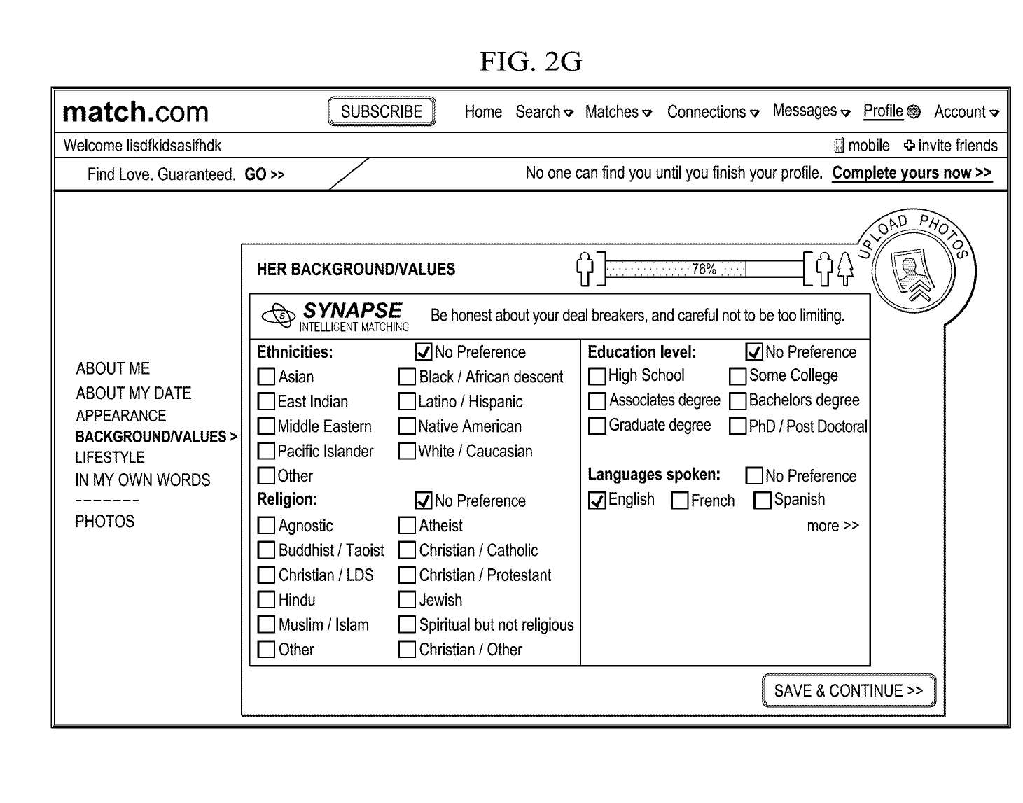

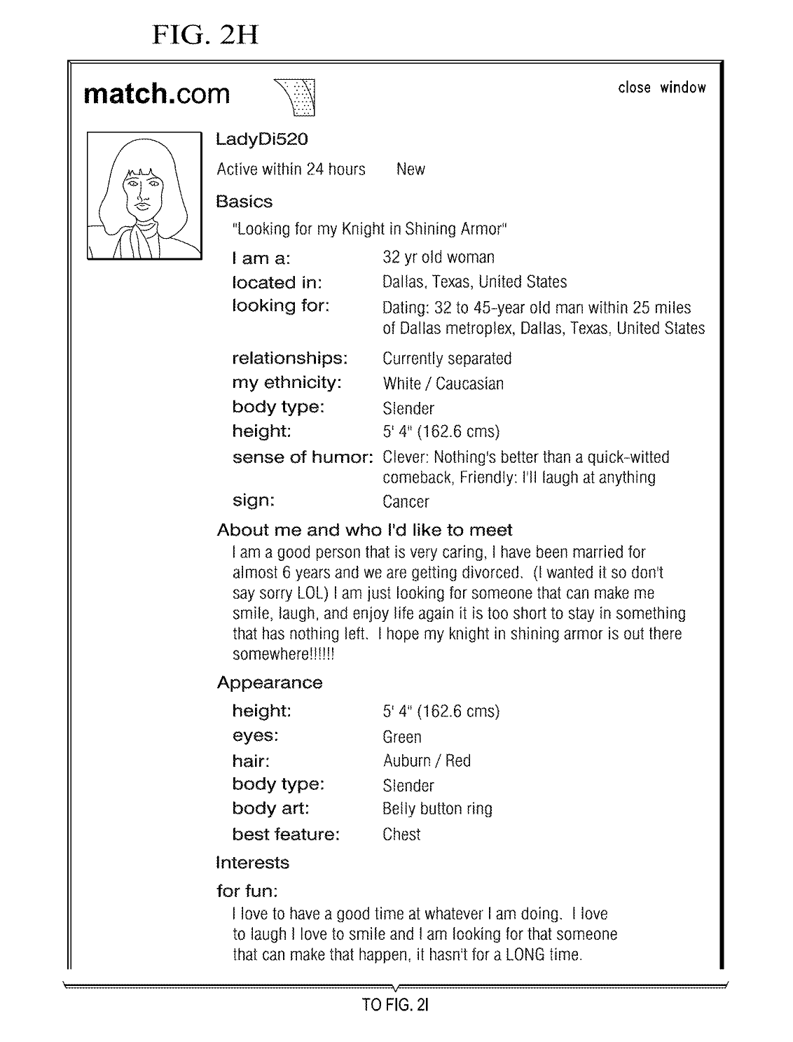

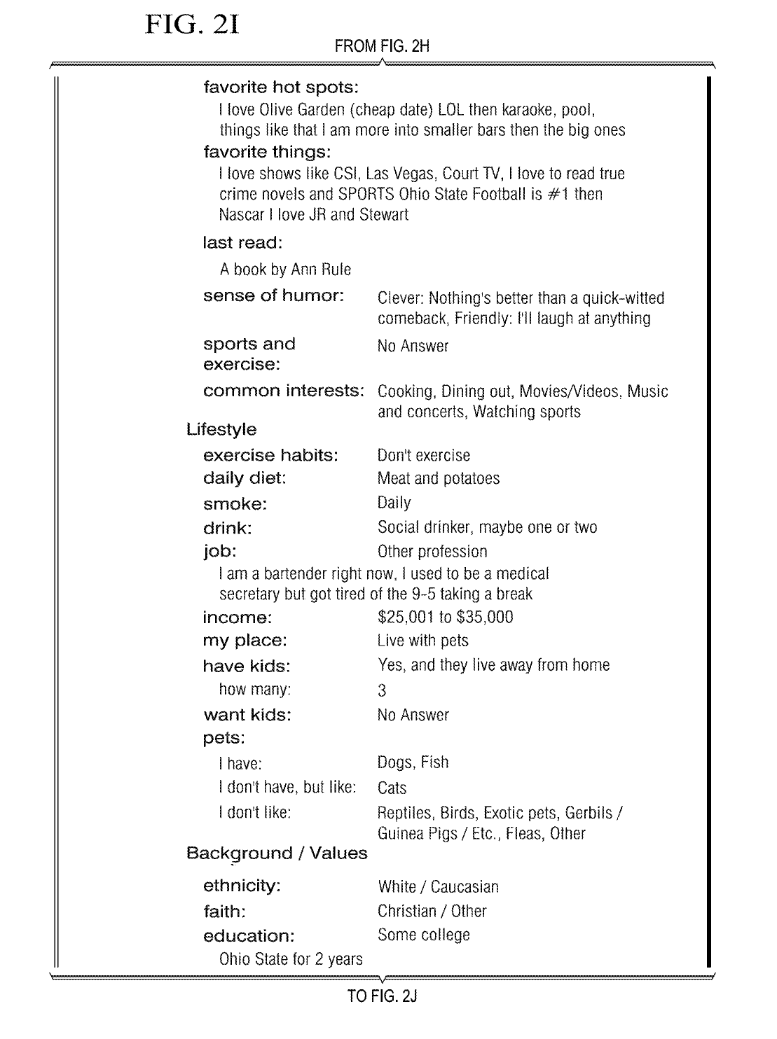

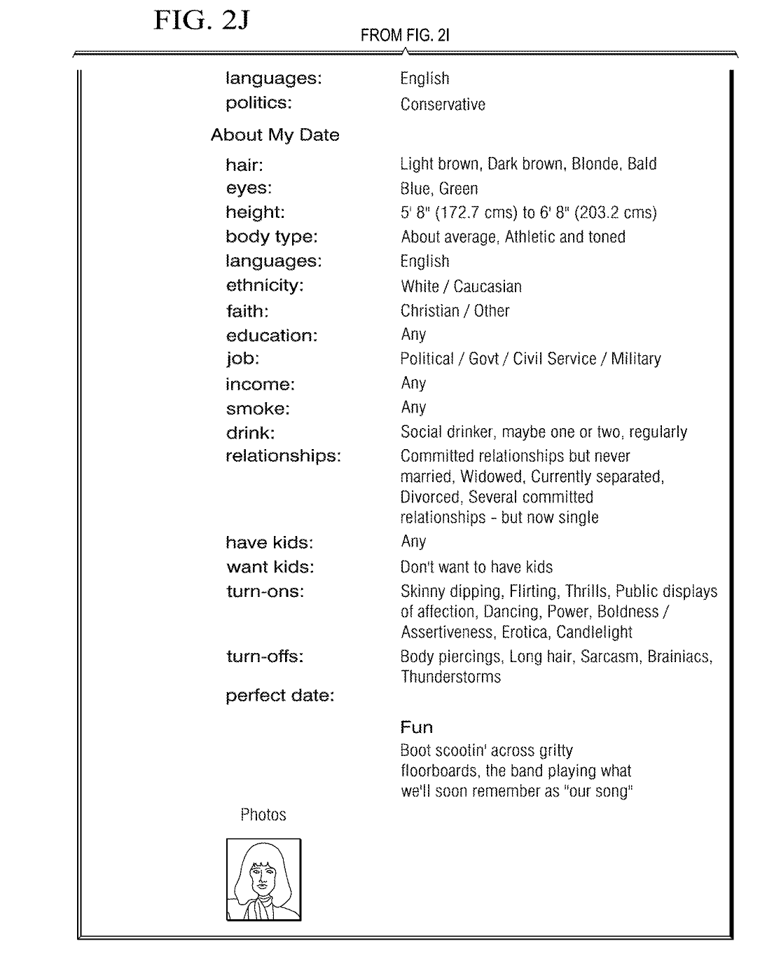

Once a photo of the user has been taken/selected, the user may edit the photo, as illustrated in FIG. 5. After all of the user's information, including the photo, has been submitted, as illustrated in FIG. 6, the user is prompted to begin developing a date request. The first step in the date request process is to select a calendar date on which the user would like to conduct the date. This is illustrated in FIG. 7, in which several calendar dates are presented to the user. The user selects a calendar date by clicking the box corresponding to the desired calendar date and then clicks a next button 40. It will be assumed for the sake of example that the user selects Monday, May 8 (FIG. 8). Next, the user is prompted to select a location for the date. In one embodiment, as illustrated in FIG. 9, the user is presented with a map with a variety of locations indicated by markers, such as markers 50-60. The locations indicated on the map may preferably be conveniently located proximate the user's current location or some other location that has been designated by the user. Alternatively, the user may search for a particular location (e.g., by entering a search query in a field 62, or may select a category, via a drop down menu 64, to filter displayed locations by type or some other criteria). Hovering the mouse cursor or other pointer over one of the markers 50-60 results in display of additional information regarding the location designated by the marker, as illustrated in FIG. 10. In the example illustrated in FIG. 10, “The Royal Tea Club” is designated by the marker 54. A web address and a physical address for The Royal Tea Club are displayed for the user's convenience. Selecting “Pick This Place” results in the displayed location being selected as the location for the date.

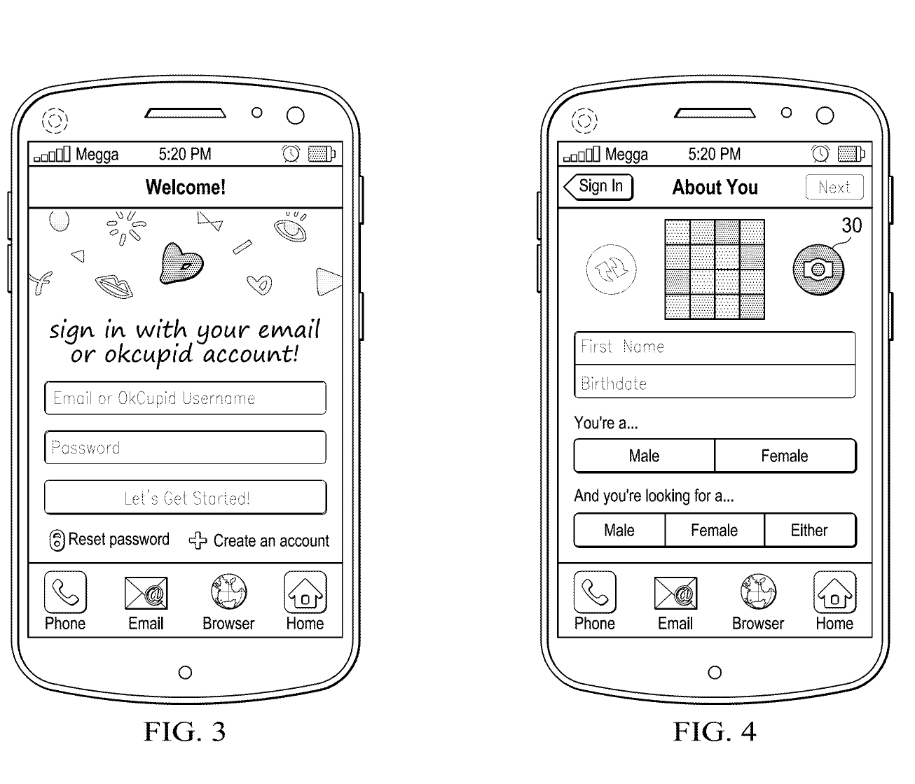

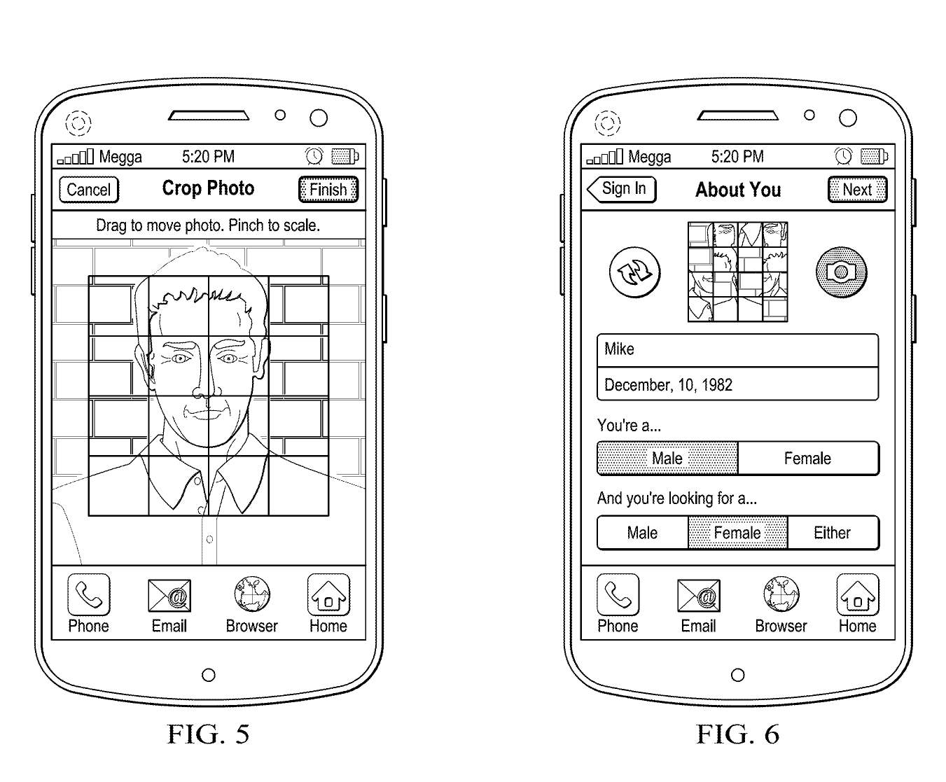

Once the user has selected a calendar date and location for his or her date, as illustrated in FIGS. 6-10, a search is conducted on a pool of date requests submitted by other users of the BDR feature to identify other users who have submitted identical or substantially similar (in terms of calendar date and location) date requests using the BDR feature. A screen such as that shown in FIG. 11 may be presented to the user while the system is searching for matches. Once the search has completed, a screen such as that shown in FIG. 12 may be presented to the user to notify the user of the number of potential matches found for the user's date request. [Note that in certain embodiments (but not all), the system can implement a filter that honors the “blind date” scenario such that the users that are matched using the BDR feature have not previously interacted online, through e-mail communications, or on the website (e.g., match.com).]

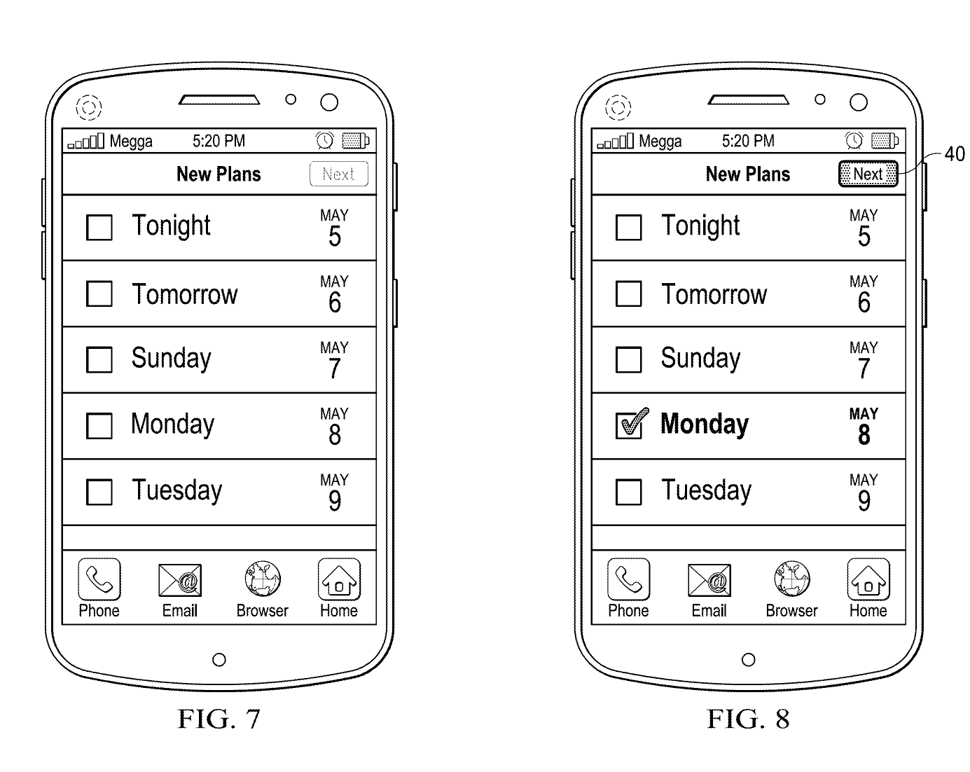

In the illustrated example, the user is notified that two matches have been identified at (or near) the location and on date specified in the user's date request. FIG. 13 illustrates a display of a first one of the identified matches. As shown in FIG. 13, the information provided to the user for the “match” is the same information solicited from the user as described with reference to and illustrated in FIG. 4, including the match's first name, age, gender, and sexual orientation; however, the match's picture has been partially obfuscated in any appropriate manner (e.g., by “puzzlization”) to disguise the actual appearance of the user. Other techniques can involve distorting the image through pixel manipulations, removing certain blocks of image data, contorting the image (e.g., much like that of a funhouse mirror), etc. In this manner, the user may ascertain a general idea of the match's features (eye color, hair color, etc.), but the puzzlization will advantageously impede the ability of the user to base his or her selection solely on the physical appearance of the match. Although not shown, the user may “scroll” to pages displaying the other matches using one of any number of known navigation techniques.

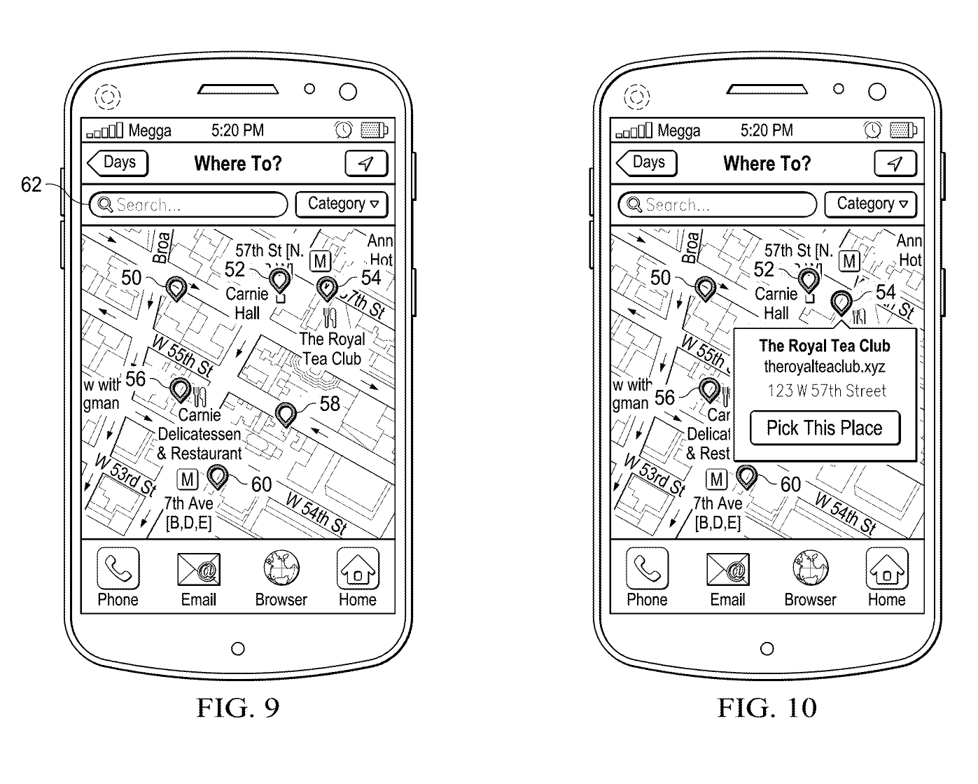

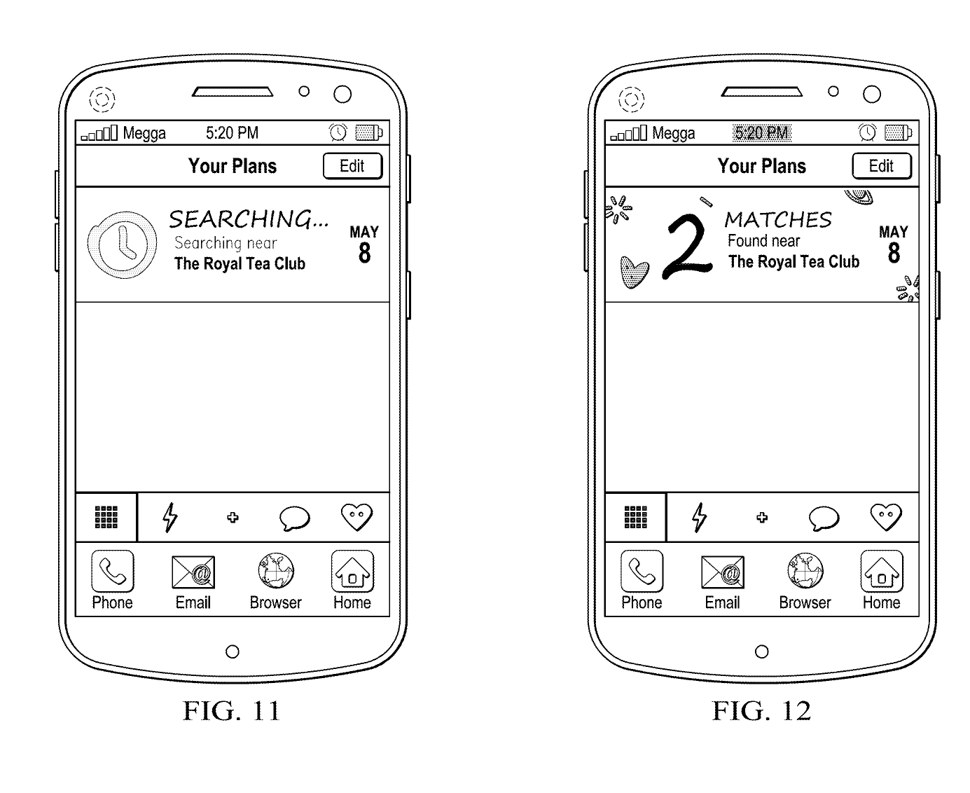

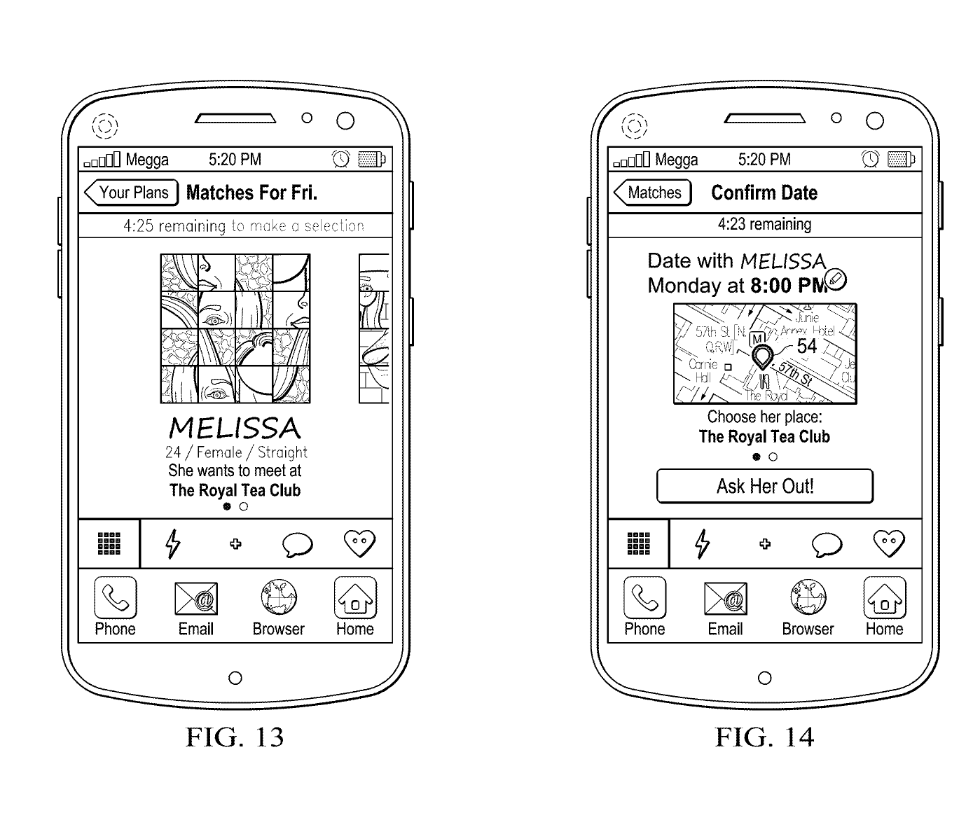

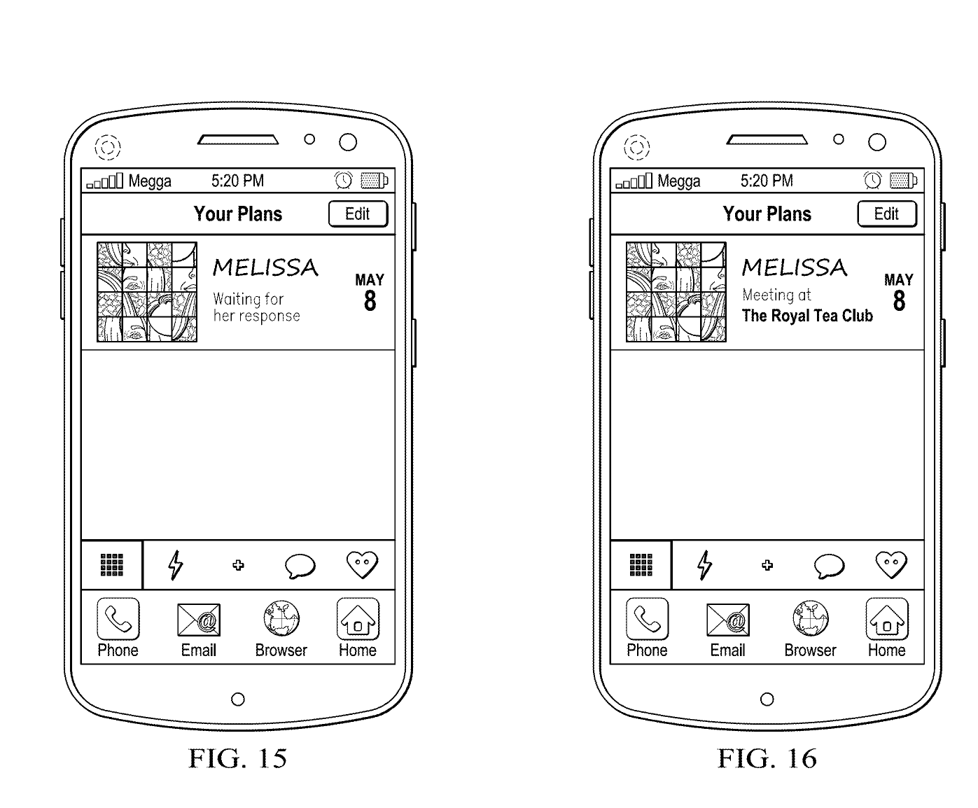

Assuming the user selects the match shown in FIG. 13 (“Melissa”), a confirmation screen is displayed, as shown in FIG. 14. Selecting “Ask Her Out” on the confirmation screen results in a date invitation being sent to Melissa. The date invitation will provide Melissa with the same information about the user that was provided to the user about her, including the user's name, age, gender, sexual orientation, and a puzzlized version of the picture the user submitted as illustrated in FIG. 4. Melissa can use this information to determine whether to accept or decline the received date invitation. The user may access a “Your Plans” page to determine the status of the date invitation. For example, as illustrated in FIG. 15, until Melissa has accepted or declined the date invitation, the user's plans will reflect that the user is waiting for Melissa's response. Assuming Melissa accepts the date invitation, the user's Your Plans page will be updated to reflect that the date has been confirmed, including the date and location of the date, as shown in FIG. 16. Clicking on the entry shown in FIG. 16 may result in display of more detailed date information, as illustrated in FIG. 17. It will be recognized that some other additional form of notification, such as an email or text message, may be provided to the user to advise the user of his/her date's response to the invitation.

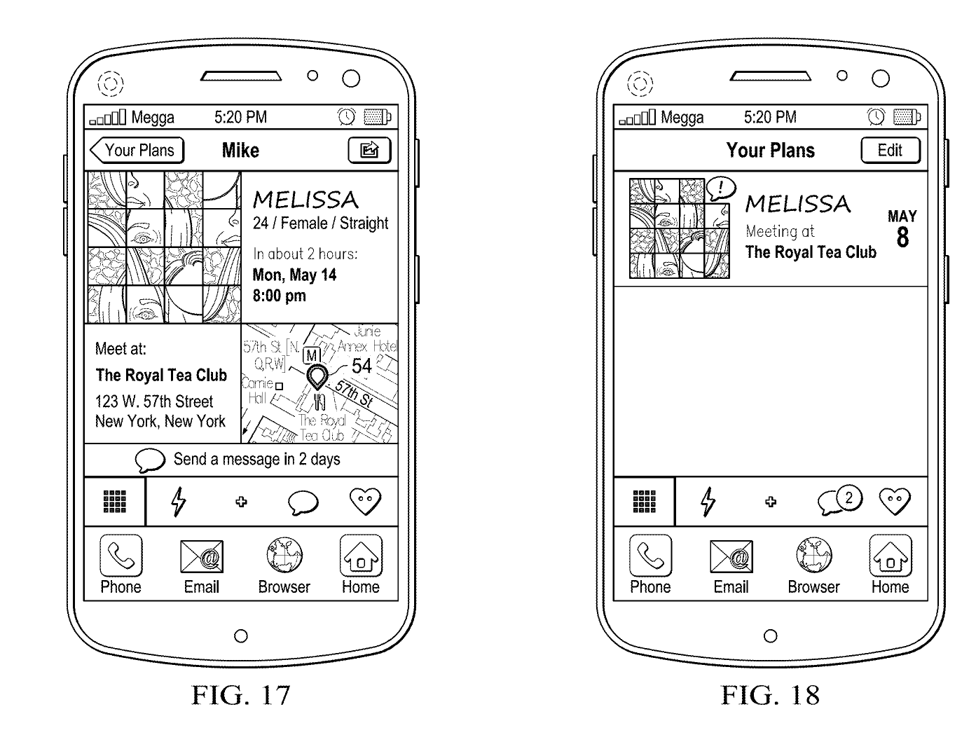

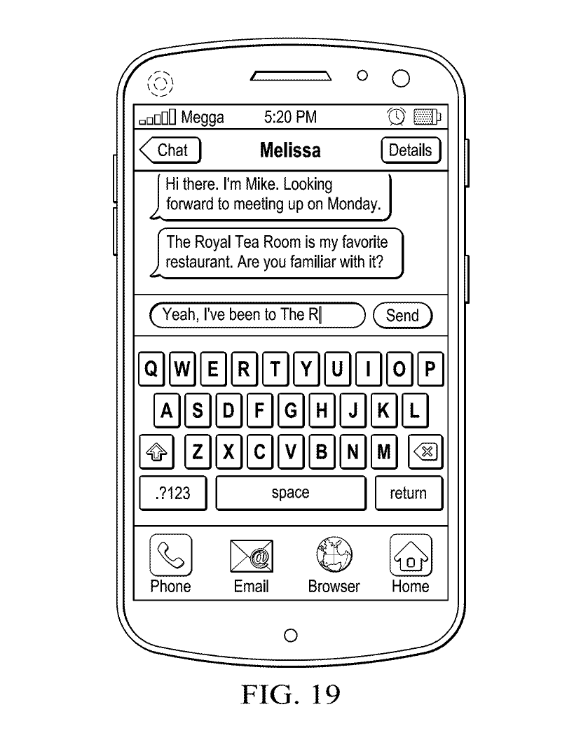

Referring to FIG. 18, a message icon 70 at the bottom of the page can be used to message, or chat with, the match and also reflects a number of messages received from the match. Clicking on the message icon 70 opens a chat window, as shown in FIG. 19, which enables the user and the match (e.g., Mike and Melissa) to refine their date plans, for example, or to familiarize themselves with one another before the date. In one embodiment, the message icon 70 is activated only between two users who have mutually agreed to a date via the BDR feature in the manner described herein.

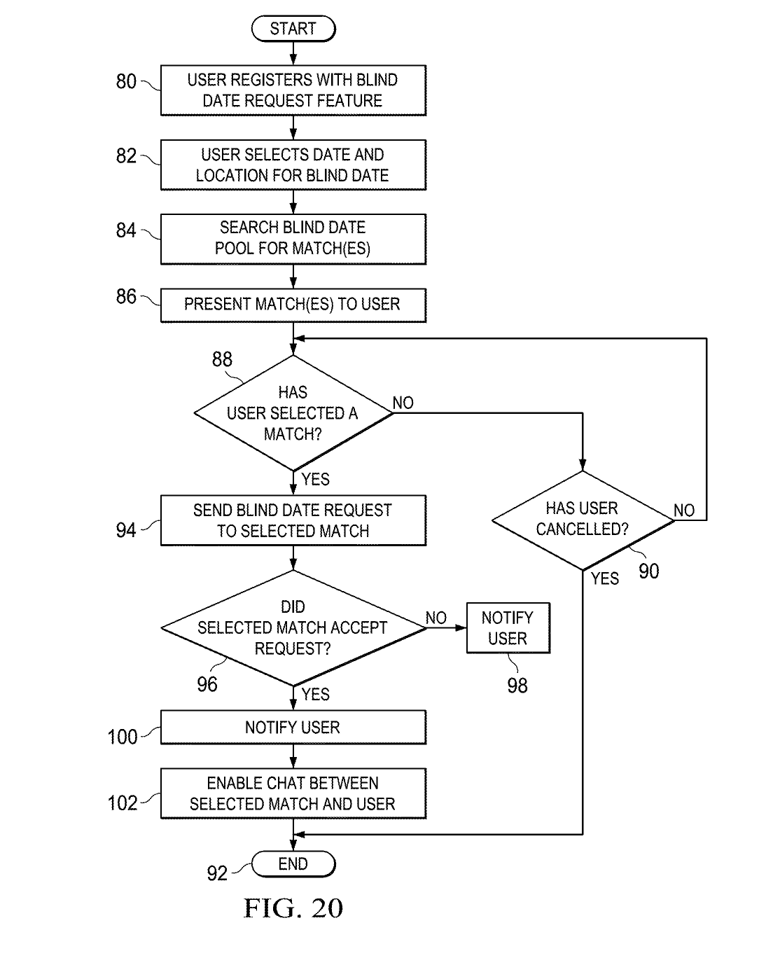

FIG. 20 is a flowchart illustrating logic implemented by a BDR feature in accordance with one embodiment. In one embodiment, the logic for implementing the BDR feature (potentially to be embodied in software) could be provided in web server 16. In step 80, a user accesses the BDR feature and registers to use the feature (as shown in and described with reference to FIG. 4). As noted above, information solicited during the registration process may include the user's first name, age (or birthdate), gender, and sexual orientation (e.g., straight, gay, or bisexual). The user will also provide a picture during the registration process of step 80. In step 82, the user selects a calendar date on which he or she would like to schedule a date. It will be recognized that this step may be performed in any number of manners. For example, the user may be presented with a list of calendar dates proximate the current calendar date from which to select one, as illustrated in FIGS. 7 and 8. Alternatively, the user may be prompted to enter a calendar date in a designated format or may be presented with a calendar from which to select a date by clicking on the corresponding day. Also in step 82, the user selects or enters a location for the date. As with the calendar date selection process, the location selection process may be performed in any number of manners, such as in the manner illustrated in FIGS. 9 and 10 or by enabling the user to enter a search query and select a location from the search results or to select a criteria by which to filter results and then select from a list of locations corresponding to the selected filter. It should be recognized that numerous instances of step 82 may be being implemented simultaneously and/or consecutively, with all of the date requests being added to a “pool” of potential matches to be accessed by the BDR feature.

In step 84, a pool of potential matches comprised of unfulfilled date requests submitted by other users via the BDR feature in the manner described above is searched to identify other users who have entered similar and/or identical date requests. It will be recognized that the date request submitted by the current user/searcher will be entered into the pool as well for others who subsequently use the BDR feature to request a date. It will be further recognized that the BDR feature may be customized only to provide to the user matches that are identical to the date request submitted by the user or may also provide matches that are within a certain tolerance of the calendar date/location indicated in the user's date request. For example, a user who has selected a particular coffee house as the location for the date may be willing to entertain the idea of conducting the date at a different coffee house located near the one originally selected.

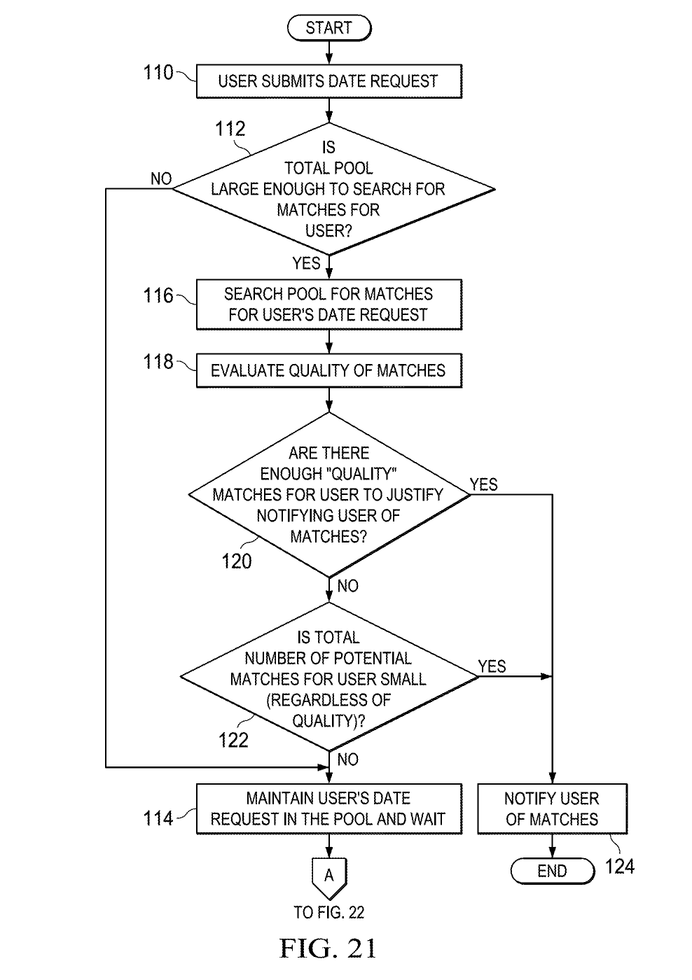

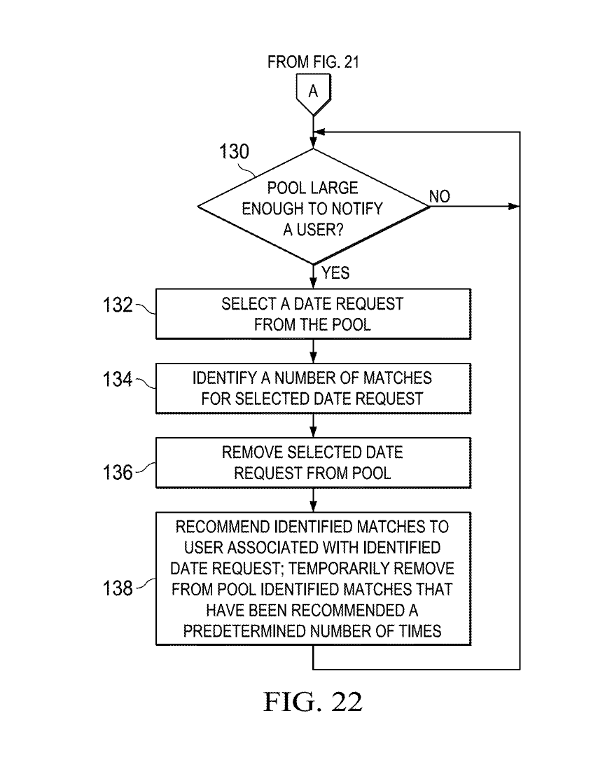

FIGS. 21-22 together illustrate a more detailed flowchart of logic implemented by a BDR feature in accordance with one embodiment. In step 110, a user submits a date request to the BDR feature, as described in detail above. In step 112, a determination is made whether the date request pool is large enough to search for matches for the user. The determination made in step 112 is based on the number of date requests in the date request pool that correspond to users who the current user would be interested in dating. For example, if the current user is a heterosexual man, in step 112, a determination is made whether the pool comprises a sufficient number of date requests from heterosexual women to justify searching for matches. Similarly, if the current user is a homosexual female, in step 112, a determination must be made whether the pool comprises a sufficient number of date requests from other homosexual women to justify searching for matches. Additionally, other factors, such as geographic location and similar age, may be considered in making the determination in step 112. What constitutes a “sufficient number” is configurable and may depend on the circumstances.

If in step 112 it is determined that the pool is not large enough, execution proceeds to step 114, in which the user's date request is placed in the date request pool to await further processing (as described below with reference to FIG. 22). However, if in step 112, it is determined that the date request pool is large enough to search for matches for the user, execution proceeds to step 116. In step 116, a search of the date request pool is executed to identify matches for the user. In step 118, the matches identified in step 116 are evaluated for quality. “Quality” matches are matches comprise date request that have been submitted by users that would likely be acceptable to the current user, in terms of gender, age, interests, etc. It will be recognized that these feature may be determined using the respective user profiles of the users in the system 10. In step 120, a determination is made whether there are a sufficient number of quality matches for the user to justify notifying the user of the matches. If not, execution proceeds to step 122, in which a determination is made whether the total number of potential matches for the user is small, regardless of quality. For example, if a user lives in a small town, there may, by definition, only be a small number of users/date requests from which to choose. In this manner, step 122 functions as a sort of “reality check”; in other words, if the search results are about as good as can be expected, based on some external criteria, it does not make sense to continue to wait for better results. If a negative determination is made in step 122, execution proceeds to step 114, described above; otherwise, execution proceeds to step 124. Similarly, if a positive determination is made in step 120, execution proceeds to step 124. In step 124, the user is notified of the matches developed in step 116. In one embodiment, the user is notified of only a certain number of matches (e.g., four) even if more matches have been identified. The matches selected for presentation to the user may be selected based on the quality of match with respect to the user. Additionally and/or alternatively, it will be recognized that date requests selected from the pool may be recommended to more than one user at the same time; therefore, the matches selected for presentation to a user may comprise those matches that have not already been recommended to multiple users, thereby to decrease the possibility of a single user receiving multiple invitations in connection with a single date request. In certain cases, algorithms may be used in order to ensure that the pool is approximately loadbalanced such that users receive a roughly equal share of possible dating opportunities. Furthermore, user profiles can be evaluated in order to determine (for example, based on a lack of matching activities, or a lack of communication or solicitations involving other users at the website,) which users should receive priority for the BDR opportunities. This could involve heightened placement opportunities for a stagnating user, increased presentment opportunities (e.g., where the user could be featured more for other users to consider), etc.

Referring now to FIG. 22, in step 130, a determination is made whether the date request pool is large enough (in terms of raw numbers of date requests in the pool) to justify attempting to fulfill a date request therefrom. In step 132, a date request is selected from the pool. In one embodiment, a date request submitted by a “high priority” user is selected. A high priority user may be one who is highly rated by other users based on various criteria; alternatively, a high priority user may be one who has had one or more (subjectively) negative dating experiences with others on the site and who is “due” a positive dating experience. In other cases, a high priority user may be reflective of a user profile that is somewhat stagnant on the website (e.g., a lack of communications or solicitations, as discussed above). Hence, any suitable historical data may be used in order to designate a particular one of the users in a pool as having some type of priority. The priority would allow for the stagnating user to receive preferential treatment (e.g., listed first in a queue for another user, presented first (or at the top of a queue) for a requester in a BDR scenario, prominently displayed on the website, be the first profile that is pulled into a particular matching opportunity, etc.). Furthermore, it should be recognized that selection of a date request from the date request pool may be performed in any number of different manners, depending on the goal of the system, the administrator, the company collecting revenues for providing matching services, etc.

In step 134, a number of matches are identified for the date request, based on date and location. It will be recognized that the number of matches provided to a user may be limited to a particular maximum number; if less than the predetermined maximum number of matches are identified, then all of the matches will be presented to the user, as described below. In step 136, the date request submitted by the identified user is removed from the date request pool. In step 138, the identified matches are recommended to the identified user. Additionally, identified matches that have been recommended to a predetermined number of users (e.g., five) are temporarily removed from the pool to reduce the risk of conflicting matches. Execution then returns to step 130.

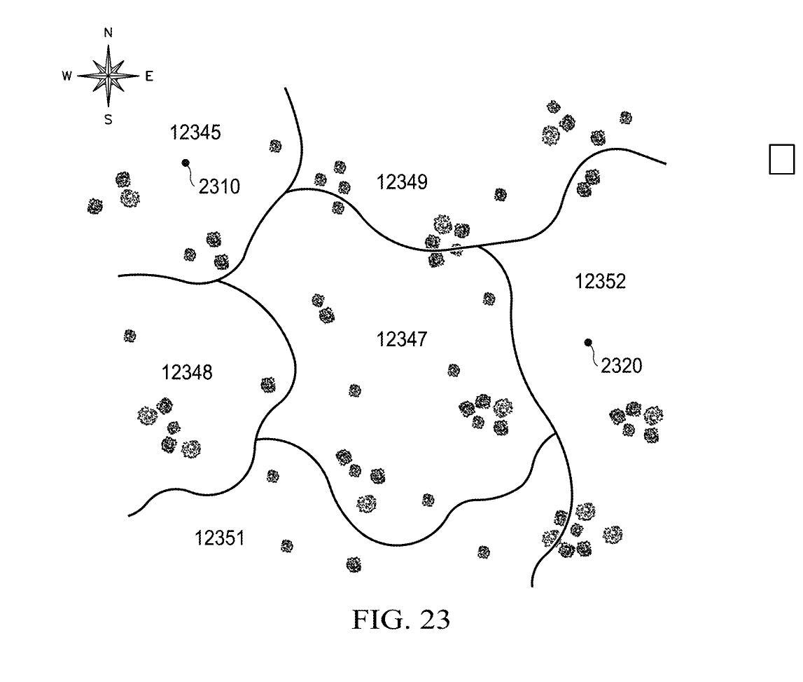

FIG. 23 is a graphical representation of a first user and second user who are geographically separate according to one or more example embodiments of the present specification. For example, first user 2310 may be “Tom” and second user 2320 may be LadyDi520. At some point in their interaction, Tom and LadyDi520 may decide to meet in person. This may be, for example, a BDR as in the foregoing paragraphs, or it may be a more traditional date request. In other cases, Tom and LadyDi520 may have previously met and decide, perhaps spontaneously, to meet up again. Thus, in certain cases, first user location 2310 and second user location 2320 may be home addresses as stored in a user profile, work locations as stored in a user profile, or current locations as determined by GPS. In other examples, Tom may be able to see LadyDi520's location, but it may be partially obfuscated. For example, he may be permitted only to see her city or zip code.

In the example of FIG. 23, first user location 2310 is located in zip code 12345, while second user location 2320 is located in zip code 12352. Upon receiving a request from one of the users, server 16 may search for an intermediate location. For example, in this case, both users' zip codes are adjacent to zip code 12347, and both are approximately the same distance therefrom. Thus, it may be beneficial for server 16 to recommend a meeting location, such as a bar or restaurant, somewhere in location 12347. In another example, a true geographic center such as geographic center 2410 may be identified based on the geometric centers of the two zip codes, and an appropriate search radius, such as three miles, may be defined.

Server 16 may have access to a geographic information system (GIS) database or other similar resource from which it may identify suitable locations in zip code 12347. Server 16 may also cross-reference its search with user profile data from one or more of the users. For example, if LadyDi520's favorite restaurant is located in zip code 12347, as read from her user profile, server 16 may recommend that as a meeting location to Tom.

In other cases, first user location 2310 and second user location 2320 may not have a co-adjacent zip code, and may be separated by substantially greater distance. For example, if Tom is located in Seattle, Wash. and LadyDi520 is located in New York, N.Y., they may nevertheless decide that they are compatible enough to warrant an in-person meeting. While in some cases, they may decide it is beneficial to meet in one city or the other, they may alternately decide that it is beneficial to meet in an in-between location. For example, server 16 may identify Sioux Falls, S.Dak. as the largest city that is approximately halfway between the two locations (approximately 1,400 miles from New York, NY and approximately 1,500 miles from Seattle, Wash.). Further, depending on the timing and user preferences, server 16 may recommend locations or events for the meeting. For example, if Tom and LadyDi520 both list Jazz music as interests, server 16 may recommend the Sioux Falls Jazz and Blues Festival, whereas if they both lists sports as an interest, server 16 may recommend a Sioux Falls Canaries baseball game or Sioux Falls Stampede hockey game.

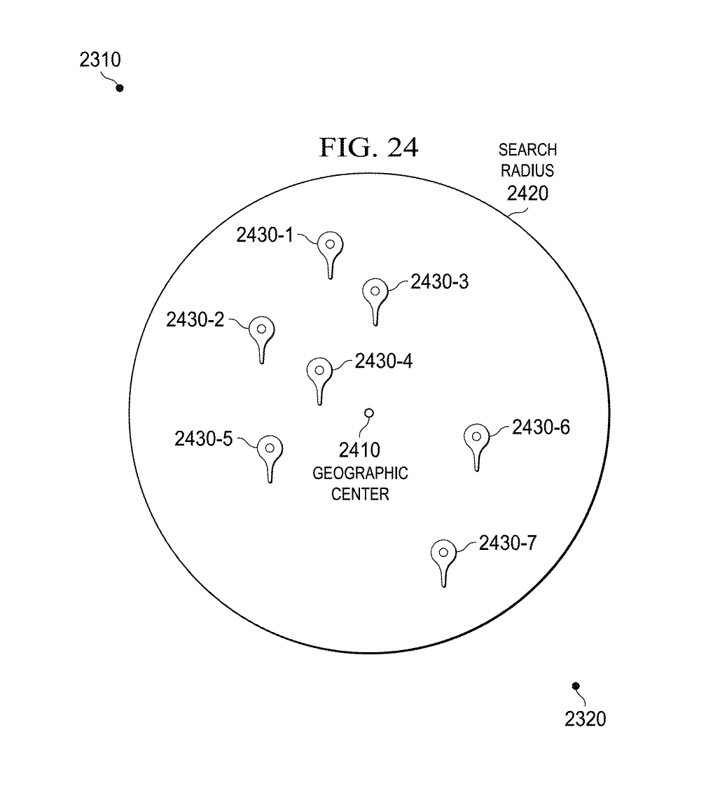

Turning to FIG. 24, first user location 2310 and second user location 2320 are separated by some distance D. At a midpoint of D is a geographic center 2410. The midpoint may be calculated, for example, by converting a longitude and latitude to radians, then finding a center and bearing between the two points, then converting back to latitude and longitude. In some instances, where precise locations are known, such as an exact address or a GPS location, it may be possible to measure geographic center 2410 with high accuracy. In other cases, where for example only a zip code is known, geographic center 2410 may be defined with a more “fuzzy” resolution. In those cases, geographic center may be measured, for example, from the geometric “center of mass” of the two zip codes, or may be determined based on whether there are any co-adjacent zip codes, or based on the number of zip codes intervening between the two locations on a straight line. It should also be appreciated that many other means for identifying an approximate geographic center 2410 are also possible, and those are intended to be encompassed within the broad scope of this specification.

For convenience of discussion, it will be assumed that first user location 2310 and second user location 2320 have been precisely determined based on exact GPS coordinates, or that a center-of-mass of a two zip codes will be used, and that geographic center 2410 is therefore a precise geographic midpoint on a straight line between the two. There is also defined a search radius 2420, which in this example is disclosed as a circular radius centered on geographic center 2410. It should be noted, however, that a circular radius is disclosed by way of example only, and that other means of identifying a search radius 2420 may easily be substituted. For example, search radius 2420 may be defined by the geographic bounds of the zip code that geographic center 2410 falls into, or may include adjacent zip codes. It should also be noted that while the size of search radius 2420 may be arbitrarily chosen, for example in response to a user selection, search radius 2420 may also be scaled according to the length of D. For example, if Tom and LadyDi520 are separated by only one zip code, they are likely to require a much tighter radius for search radius 2420 (such as three, six, or nine miles) than if they live in Seattle, Wash. and New York, N.Y. respectively. Furthermore, for users located nearby and in an urban area, geographic center 2410 is more likely to be located relatively close to suitable meeting locations, whereas the exact geographic center between Seattle, Wash. and New York, N.Y. is more likely to be a rural area without an appropriate meeting location. Thus, in cases where first location 2310 and second location 2320 are separated by more than a threshold distance, for example 200 miles, geographic center 2410 may be defined as the nearest major or minor airport to the true geographic center.

In one example, selection of the midpoint may be influenced not only by geographic distance, but also by popularity, or selection of a “hot spot.” For example, a bar district near the geographic center may be selected as the midpoint.

In an example, server 16 identifies a plurality of possibly suitable meeting locations 2430. These may be displayed on a map, so that the users can visibly see exactly where each proposed location is located. In a further example, server 16 may rank and/or categorize recommendations. For example, server 16 may display bars by default, but may also provide an option to select restaurants, cafes, coffee houses, dance halls, clubs, activities (such as bowling or miniature golf), or movie theaters by way of non-limiting example. Further, server 16 may refine initial recommendations based on user profile information. For example, if one or both of Tom or LadyDi520 lists their “faith” as Mormon or Muslim, or if one of them is a member of Alcoholics Anonymous, bars and clubs may be given lower precedence than restaurants or cafes. Further, if geographic center 2410 falls in a bar district, search radius 2420 may be automatically expanded to capture more suitable venues.

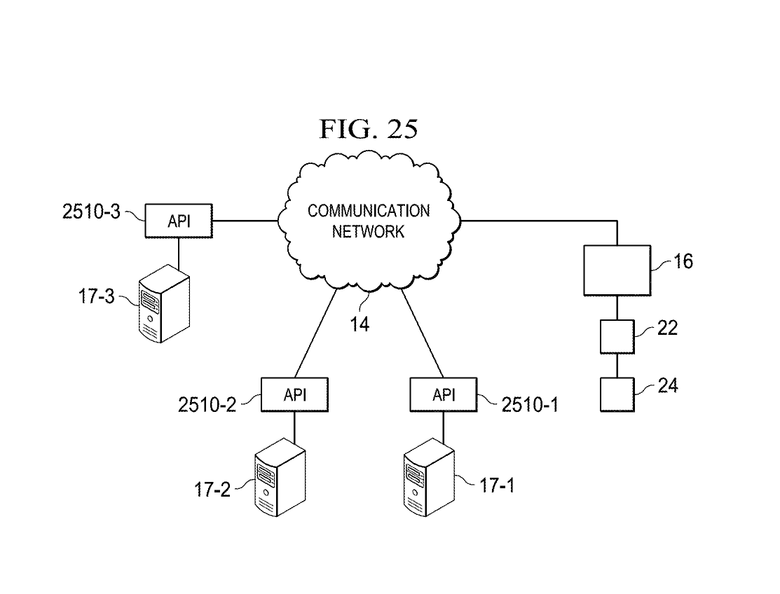

FIG. 25 is a network diagram of a server 16 interacting with a plurality of third-party servers 17. Each third-party server 17 provides an application programming interface (API) 2510. Each API may be configured to provide a certain type of data useful to server 16. For example, third-party server 17-1 may provide API 2510-1, which may be an API providing access to geographic information system (GIS) data. GIS data may be useful, for example, in matching GPS coordinates to map locations, in calculating a geometric center of mass of a zip code, or otherwise retrieving and processing geographic data. As of the date of this patent application, GIS services include Google, Yahoo, Bing, and MapQuest by way of non-limiting example.

API 2510-2, operated by third-party server 17-2, may be for example a database of potential meeting locations. This may provide, for example, names, types or classes of goods or services, user reviews, star rankings, branding, and other related information. Non-limiting examples of such APIs as of the date of this patent application include Google Places and City Grid.

API 2510-3, operated by third-party server 17-3, may be for example a map display API, which may be used to display a map with the suggested meeting locations flagged, and may include links to additional information about the meeting locations.

It should be noted that these three APIs are disclosed by way of example only, and other APIs may be used. It is further noted that, while these APIs are shown as third-party APIs by way of non-limiting example, it is possible for similar features to be hosted internally to server 16. Accordingly, in this specification, “Application Programming Interface” is expressly defined as a service, remote from, local to, or integrated into a server that is configured to provide requested information.”

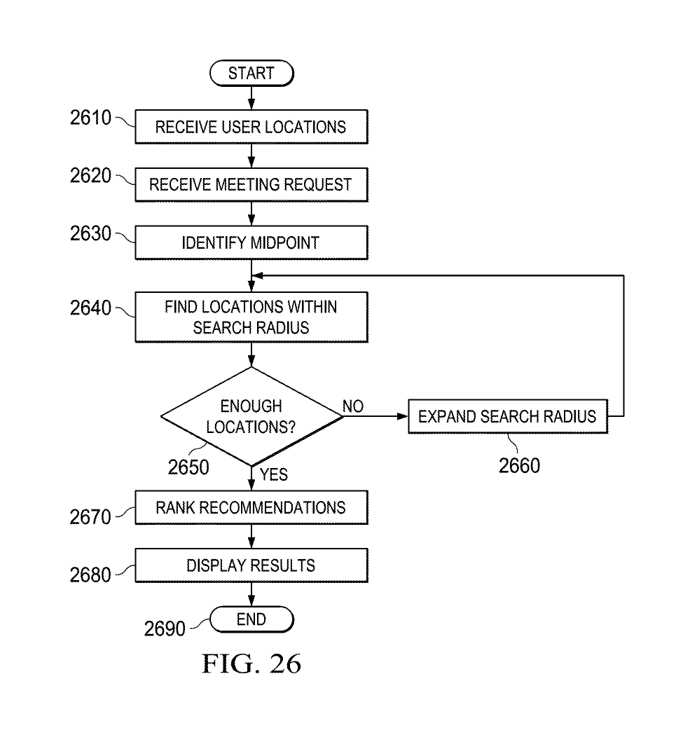

FIG. 26 is a flow diagram of an example method of automatically recommending intermediate meeting locations according to one or more example embodiments of the present specification. It is expressly noted that although this method is disclosed as a series of sequential steps, the sequence need not be preserved. By way of non-limiting example, in some embodiments, blocks 2610 and 2620 may change places.

In method 2600, at block 2610, server 16 may extract user locations for the first user and second user. This may be done, for example, by reading location data for a home, work, or other preferred address from a user profile. In another example, the first user and second user decide to meet spontaneously, and both being equipped with GPS receivers, server 16 receives a current GPS location from each. In other examples, the first user and second user may manually enter their respective locations, such as entering a an address or intersection, or interactively pointing to a current location on a map. In another example, the user locations need not represent the users' current locations, but may represent anticipated future locations. For example, if the first user knows that he will be traveling to the second user's city in the near future, he may enter the location of the hotel where he will be staying, whereas the second user may enter her home address. Many other variations of identifying a user's location are possible, and it is expressly intended that “receiving a user's location” broadly encompass all of the foregoing.

In block 2620, server 16 may receive a meeting request from one or both of Tom and LadyDi520. It should be noted that a user-initiated date request is disclosed herein by way of example only, and that block 2620 may comprise, for example, an automated or inferred event, and the meeting need not be a romantic date, but could be a business meeting or transfer of goods by way of non-limiting example. Thus, it is broadly intended that “receiving a meeting request” and “sending a meeting request” encompass any event or sequence of events wherein an approximate geographic center, within a search radius, is identified on behalf of a first party and a second party. In this specification, a “meeting request” is expressly defined as an event that initiates a search for a geographic center between two users. A “search radius” is expressly defined as a range identified, in spatial or temporal terms, around a midpoint. A search radius need not necessarily be regular in shape, and need not be centered on the midpoint.

In block 2630, server 16 may identify a midpoint with a search radius between the two users' locations. A “midpoint” is expressly defined as a location that may be selected for its mutual accessibility to a first user and a second user. This may be, for example, a precise geographic center 2410 (FIG. 24). This may also be a zip code adjacent to each of the users' respective zip codes, or a zip code approximately an equal distance from each user's zip code. In another embodiment, the midpoint may be an approximate mileage midpoint along a driving path between the two users' locations, or a location separated from each user by an approximately equal distance or time. For example, if Tom needs to drive 10 miles through heavy traffic, he may reach the midpoint at approximately the same time as LadyDi520, who needs to travel 20 miles mostly over rural roads. The location of the midpoint may also be sensitive to time of day. For example, if Tom lives in a suburban area and LadyDi520 lives downtown, Tom may face heavier inbound traffic in the morning while LadyDi520 may face heavier outbound traffic in the afternoon. To this end, server 16 may integrate with a traffic service to receive real-time or near-real-time traffic updates, as well as historical traffic patterns, which may be used to calculate the midpoint. In other examples, identifying the midpoint may encompass finding an airport to which the users may fly in approximately the same amount of time, in which case search radius 2420 may be defined in terms of flight time rather than directly in terms of absolute difference. Thus, it is also intended that the “midpoint” as defined herein encompass both an approximate temporal as well as spatial midpoint where neither is expressly stated, and search radius 2420 may be defined either in terms of ΔX, where ΔX=∥D−Pos_{Tom}−|D−Pos_{LadyDi520}∥ and Pos represents each user's respective position; or ΔT, where ΔT=|Tₜₒₘ−T_{LadyDi520}| and T represents each user's respective travel time. In some cases, the search radius may be varied relative to the size of distance D between the two users.

In block 2640, server 16 may identify potential meeting locations within the search radius. In this specification, a “meeting location” is expressly defined as a true geographic position or a virtual representation of a true geographic position that may be selected for its mutual utility to a first user and a second user. As described above, meeting locations may be categorized by type, such as bars, restaurants, cafes, coffee houses, dance halls, clubs, activities (such as bowling or miniature golf), or movie theaters by way of non-limiting example.

In block 2650, there is a check for whether there are enough locations identified. For example, in one example, a minimum of ten potential locations must be identified for a search to be considered “successful.” If fewer than ten locations are identified, then in block 2660, the search radius is expanded. For example, in one embodiment, the initial search radius is three miles. If insufficient locations are found in the three-mile search radius, the radius is expanded to six miles. If insufficient locations are identified at six miles, the radius may be expanded to nine miles.

In block 2670, the recommended locations are ranked according to an algorithm. As used herein, “ranking” is expressly defined as prioritizing, classifying, filtering, winnowing, sorting, or otherwise assigning preference or precedence. Ranking may be based on user preferences, for example as expressed in a user profile, or as interactively given when the meeting request is made. In an example, precedence may be given to the invitee's preferences. For example, if Tom is inviting LadyDi520 to meet for a date, including via BDR, server 16 may give priority to LadyDi520's preferences as identified in her profile. Thus, if LadyDi520 has a preference for local non-chain cafes, while Tom has a preference for chain coffee houses, server 16 may recommend local non-chain cafes first. Results may also be ranked by other factors such as price, reviews, star ranking, special offers, ΔX, and ΔT by way of non-limiting example. In some examples, businesses may also pay for increased ranking or preferential placement, such as in a “sponsored results” section. Further, server 16 may refine rankings based on a combination of factors, such as star ranking and user preferences. Again, although a date, including a BDR, is disclosed by way of example, many other applications are also anticipated by this specification. For example, if the meeting is a business meeting, business-appropriate facilities may be given priority. If, on the other hand, the purpose is delivery or transfer of goods, a suitable location may be identified and given priority.

In block 2680, ranked meeting locations are displayed to the user. Displaying may take the form of screen display, text display, audio display, network communication, or any other method of conveying information to the user. In block 2690, the method is complete.

Although the present disclosure has been described in detail with reference to particular embodiments, it should be understood that various other changes, substitutions, and alterations may be made hereto without departing from the spirit and scope of the present disclosure. For example, although the present disclosure has been described with reference to a dating protocol, any service that deals with (or that leverages) profiles, photos, resumes, user information more generally, etc. could readily benefit from the present disclosure.

Moreover, although the present disclosure has been described with reference to a number of elements included within system 10, these elements may be rearranged or positioned in any appropriate manner to accommodate any suitable networking configurations. In addition, any of the elements of FIG. 1 may be provided as separate external components to system 10 or to each other where appropriate.

It should also be noted that any of the question portions of the platform can leverage any type of format. Thus, in any aspect of the online dating process described herein, such as establishing a personality profile, for example, any suitable question format can be employed. Example formats include a Yes/No format, a multiple choice question format, a short answer format, a true/false format, etc. Other formats can readily be used in order to achieve the desired responses and solicit the necessary data.

Note that in certain example implementations, the matching and/or location identifying functions outlined herein, such as those carried out by web server 16 and/or provided as an application for an endpoint being operated by an end user (e.g., a mobile application for an iPhone™), may be implemented by logic encoded in one or more non-transitory, tangible media (e.g., embedded logic provided in an application specific integrated circuit (“ASIC”), digital signal processor (“DSP”) instructions, software (potentially inclusive of object code and source code) to be executed by a processor, or other similar machine, etc.). In some of these instances, a memory, as shown in FIG. 1, can store data used for the operations described herein. This includes the memory being able to store software, logic, code, or processor instructions that are executed to carry out the activities described in this Specification.

A processor can execute any type of instructions associated with the data to achieve the operations detailed herein in this Specification. In one example, the processor, as shown in FIG. 1, could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (“FPGA”), an erasable programmable read only memory (“EPROM”), an electrically erasable programmable ROM (“EEPROM”)) or an ASIC that includes digital logic, software, code, electronic instructions, or any suitable combination thereof.

These devices illustrated herein may maintain information in any suitable memory (random access memory (“RAM”), ROM, EPROM, EEPROM, ASIC, etc.), software, hardware, or in any other suitable component, device, element, or object where appropriate and based on particular needs. Any of the memory items discussed herein should be construed as being encompassed within the broad term “memory.” Similarly, any of the potential processing elements, modules, and machines described in this Specification should be construed as being encompassed within the broad term “processor.” Each of the network elements can also include suitable interfaces for receiving, transmitting, and/or otherwise communicating data or information in a network environment.

Note that with the example provided above, as well as numerous other examples provided herein, interaction may be described in terms of more than one network element. However, this has been done for purposes of clarity and example only. In certain cases, it may be easier to describe one or more of the functionalities of a given set of flows by only referencing a limited number of network elements. It should be appreciated that system 10 (and its teachings) are readily scalable and can accommodate a large number of components, as well as more complicated/sophisticated arrangements and configurations. Accordingly, the examples provided should not limit the scope or inhibit the broad teachings of system 10 as potentially applied to a myriad of other architectures.

It is also important to note that the steps in the preceding flow diagrams illustrate only some of the possible signaling scenarios and patterns that may be executed by, or within, system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by system 10 in that any suitable arrangements, chronologies, configurations, and timing mechanisms may be provided without departing from the teachings of the present disclosure. Although the present disclosure has been described in detail with reference to particular arrangements and configurations, these example configurations and arrangements may be changed significantly without departing from the scope of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
receiving location data for a first user and a second user;
receiving a meeting request;
identifying a midpoint between the first user and second user;
defining a search radius around the midpoint;
searching for meeting locations within the search radius; and
displaying the meeting locations.

2. The method of claim 1 further comprising ranking the meeting locations.

3. The method of claim 2, wherein ranking the meeting locations comprises applying a criterion selected from the group consisting of business type, price, reviews, star ranking, special offers, ΔX, ΔT, and sponsorship status.

4. The method of claim 1 further comprising identifying an expanded search radius if insufficient meeting locations are identified within the first search radius.

5. The method of claim 1, wherein the search radius is between three and nine miles.

6. The method of claim 1, further comprising:
identifying a distance D separating the first user from the second user; and
if D is greater than a threshold, identifying an airport as the midpoint.

7. The method of claim 6, wherein the threshold for D is approximately 200 miles.

8. The method of claim 1, wherein the meeting request is a blind date request.

9. A non-transitory computer-readable storage medium having stored thereon instructions operable to:
receive location data for a first user and a second user;
receive a meeting request;
identify a midpoint between the first user and second user;
define a search radius around the midpoint;
search for meeting locations within the search radius; and
display the meeting locations.

10. The computer-readable storage medium of claim 9, wherein the instructions are further operable to rank the meeting locations.

11. The computer-readable storage medium of claim 10, wherein ranking the meeting locations comprises applying a criterion selected from the group consisting of business type, price, reviews, star ranking, special offers, ΔX, ΔT, and sponsorship status.

12. The computer-readable storage medium of claim 9, wherein the instructions are further operable to identify an expanded search radius if insufficient meeting locations are identified within the first search radius.

13. The computer-readable storage medium of claim 9, wherein the search radius is between three and nine miles.

14. The computer-readable storage medium of claim 9, wherein the instructions are further operable to:
identify a distance D separating the first user from the second user; and
if D is greater than a threshold, identify an airport as the midpoint.

15. The computer-readable storage medium of claim 14, wherein the threshold for D is approximately 200 miles.

16. The computer-readable storage medium of claim 9, wherein the meeting request is a blind date request.

17. A server comprising:
a processor;
a network interface; and
a memory having stored thereon software instructions operable to instruct the processor to:
receive, via the network interface, location data for a first user and a second user;
receive a meeting request via the network interface;
identify a midpoint between the first user and second user;
define a search radius around the midpoint;
search for meeting locations within the search radius; and
display the meeting locations.

18. The server of claim 17, wherein the instructions are further operable to rank the meeting locations.

19. The server of claim 18, wherein ranking the meeting locations comprises applying a criterion selected from the group consisting of business type, price, reviews, star ranking, special offers, ΔX, ΔT, and sponsorship status.

20. The server of claim 17, wherein the instructions are further operable to identify an expanded search radius if insufficient meeting locations are identified within the first search radius.

21. The server of claim 20, wherein the search radius is between three and nine miles.

22. The server of claim 17, wherein the instructions are further operable to:
identify a distance D separating the first user from the second user; and
if D is greater than a threshold, identify an airport as the midpoint.

23. The server of claim 17, wherein the meeting request is a blind date request.
